(19) United States
(12) Patent Application Publication
(10) Pub. No.: US 2012/0228523 A1
(43) Pub. Date: Sep. 13, 2012

(54) BIOLOGICAL LASER PLASMA X-RAY POINT SOURCE

(75) Inventors: Krishnamurthy Manchikanti, Mumbai (IN); Krishanu Ray, Mumbai (IN); Ravindra Kumar Gattamaraju, Mumbai (IN)

(73) Assignee: TATA INSTITUTE OF FUNDAMENTAL RESEARCH, Mumbai (IN)

(21) Appl. No.: 13/508,840

(22) PCT Filed: Nov. 9, 2009
(86) PCT No.: PCT/IN2009/000632

§ 371 Date: May 9, 2012

(51) Int. Cl. H01J 35/02; G21G 4/00

(52) U.S. Cl. 250/493.1; 378/143

(57) ABSTRACT

The invention provides targets coated with structured biological materials, which are employed in laser produced plasma systems. The biological materials selected from cells of microbial, protozoan or plankton origin are applied on a portion of a solid target, like polished glass plate which then form a target system that absorbs the intense laser pulses, generates hot dense plasma and results in the emission of the X-rays. The method of coating structured biomaterial decreases the usable laser intensity required for producing the hot plasma, while increasing the X-ray yield. The coatings are easy to prepare and it is possible to vary the nature and shape of the cellular material in order to control/regulate the interaction with the light and thereby optimize the resultant plasma generation and X-ray emission. The increase in temperature of the plasma and the increase in yield demonstrate that the method is suitable for enhancing the emission yield in the Ultra Violet, Extreme Ultra violet, x-ray and the hard x-ray regimes.

### FIELD OF THE INVENTION

The present invention relates to laser produced plasma systems for X-ray generation. More particularly, it relates to targets coated with structured biological materials, which are employed as targets in laser produced plasma systems.

### BACKGROUND AND PRIOR ART

It is well known that irradiation of a solid material with intense laser field produces hot plasma, which is a gaseous mixture of free electrons, ions and neutrals. The energy of the electrons can be very large depending on the intensity of the laser and the extent of absorption of the laser energy into the matter. The electron energy distribution is Maxwellian with one or more temperatures, describing different nature of the ‘hot’ electrons and ‘cold’ electrons in the plasma. The hot electrons, which can have a temperature of few tens to hundreds of keV, interact with the target matter and produce bremstraahlung radiation. They also ionize the inner shell electrons of the atom and can lead to characteristic X-ray emission from the elements in the target. Thus the intense field produced plasma is a versatile source of X-ray radiation. Since the laser pulse can be very short, in the domain of femtoseconds, the hot electrons are generated in a short burst and the VUV/X-ray emission also occurs in a similarly short burst. Laser produced plasmas are used as source of X-rays for a wide variety of applications in lithography, biological and material microscopy, radiography, cancer therapy, non-destructive testing, imaging. etc.

Conventionally a solid slab is used as the target for absorption of the laser radiation and plasma generation. Solid density is considered vital for generating copious hot electrons and plasma formation. However, a planar solid surface absorbs only a small fraction of the incident light and reflects/scatters the rest. An improvisation of the target that improves the laser absorption and generates brighter source of X-rays has been the demand and many inventions have been reported in this regard. U.S. Pat. No. 5,151,928 teaches the use of tape cartridges as targets. U.S. Pat. No. 5,577,091 teaches frozen gases, water snow; WO/2002/085080 teaches micro-droplets of liquid while US 20080149862 teaches liquid metal that can be used as targets for generation of X-rays.

The continuing quest is for a target system, which improves the yield of X-rays and should be usable over a wide range of emission frequencies. Most of the systems used so far are very difficult to prepare and expensive. They require sophisticated engineering and material processing methods for preparing the nano-materials. It is mandatory to have complicated design of vacuum systems to maintain the required low pressure when liquid metal or micro-droplets of water are pumped in to generate snow. In addition, the use of high z-metal is not environment friendly and requires safe disposal system for handling the vapor exhausts from the vacuum system.

### OBJECTS OF THE INVENTION

It is one the object of the present invention is to overcome the drawbacks of the prior art.

It is another object of the present invention to provide a target system that enhances the X-ray yield for a given intensity of the laser used for X-ray generation.

It is another object of the present invention to ensure that the target system is versatile and can be tuned to optimize the emission characteristics of the source.

It is another object of the present invention to provide target preparation, which is very easy, simple and inexpensive.

It is yet another object of the present invention that the target system is environmentally friendly, debris free and non-toxic.

### SUMMARY OF THE INVENTION

A thin film of biological matter dispersed on a portion of a solid substrate that absorbs intense laser pulses to generate hot dense plasma resulting in the emission of radiation over a wide spectral range wavelengths down to 0.004 nm.

### BRIEF DESCRIPTION OF THE ACCOMPANYING FIGURES

FIG. 1 illustrates the system for generating X-ray from laser produced plasma using biological materials as a target for the laser absorption.

FIG. 2 illustrates the target prepared by coating biomaterial over a solid substrate.

FIG. 3 illustrates the height profile of the bacterial coating made on the solid substrate.

FIG. 4 illustrates the enhancement in the X-ray emission yield brought out due to the intact cellular coating.

### DETAILED DESCRIPTION OF THE INVENTION

The present invention provides biological cellular material as a target system that absorbs the intense laser pulses in generating hot dense plasma and would result in the emission of the X-rays. The biological cellular materials used are with varied micro- and nano-structures.

A thin film of biological matter is applied on a portion of a solid target, a polished glass plate. The biological matter used is selected from cells of microbial, protozoan or plankton origin. Regular strains of such material as the Escherichia coil bacteria grown overnight in a suspension culture in minimal media can be used. The bacterial cells can be used either live or as chemically fixed and UV attenuated form.

A laser pulse in the intensity range of 10¹⁴-10¹⁶ W cm⁻² is focused onto the target coated with said biological material. The pulse duration is chosen to be short enough to take the advantage of the micro/nano-structures of the target material. In present invention a laser that delivers pulses of widths shorter that 100 fs is used. The intensities used are in the range of 10¹⁴-10¹⁶ W cm⁻². The larger the intensities focused, larger would be the plasma electron temperature and larger would be the energy range of the emitted X-rays. The shorter the pulse duration greater would be the advantage of the micro/nano-structure of the target material.

In the present laser produced plasma methods a fresh new target surface is used for every laser pulse. To this end any method can be used to move the target so that the laser pulse is focused on a fresh new surface for each shot. Methods in the U.S. Pat. No. 5,151,928 can be used. Piezo-electric positioning devices can be used to move a solid slab to specific extents at defined time intervals. However, it is advantageous to use the same system to move the laser beam instead in a rastered fashion so that the laser pulses are focused on a new surface while the target remains stationary.

The laser is absorbed on the target and produces hot-dense plasma. Hot plasma has hot-electrons. high energy ions and high energy photons. The high energy photon emission is over a very wide range of energy panning from the Ultraviotlet to hard X-rays. The high energy photons, UV/EUV or X-rays which can be used from further application.

While the exact yield of X-ray would vary with the thickness and uniformity of the biological coating, X-ray emission yields are always higher so long as there is bacterial coating. It is not important whether the bacterial material is live or fixed. However, it is very important that the bacterial cell structure remains intact. Processes like sonication can destroy the structural integrity of the bacterial cells and this can be detrimental to the method of using bacterial coating as a means to enhancing the X-ray emission yield from the laser produced plasmas.

Irradiation of the laser on the bacterial coating produces hot dense plasma. The radiation could be collected by suitable optical elements and could be harnessed for other applications, like those illustrated in U.S. Pat. No. 5,577,091.

The X-rays emitted from the laser produced plasmas under identical conditions, both from the solid target with the bacterial coating and without it were examined by the present inventors. This gave the relative yields of the enhancements in the X-ray emissions due to the bacterial coating as compared to the bare surface. It is found that under identical laser irradiation the bacterial coating brought about 100 fold or more enhancements in the X-ray yield.

Furthermore to make higher yields of X-ray in laser produced plasma, high z-materials such as Cu, Au, etc., has been used, which produces toxic debris that deteriorates expensive optics used in imaging or lithography. In the present invention biological coatings have been employed. It is very well known that the metal content of bacteria is less than 0.05% w/w. So the high z-material debris is at best 0.05% as compared to the use of metal targets where it is relatively 100%.

Though the invention is described as an X-ray source, the laser plasma source produces radiation over a very wide spectrum (up to 0.004 nm). The bremstrahlung radiation generated from the hot electrons in the hot plasma extends from the ultra violet (UV) and extreme Ultra violet (EUV) to all the way to the very hard X-rays of photon energies as large as 300 keV. Since the plasma temperature is 2-3 times larger with the bacterial coating, emission yield over the entire spectral bandwidth should be larger. So this method generates enhanced emission of radiation over the entire spectrum and thus, it would be useful not only as an X-ray source, but also as UV and EUV source for applications in lithography, microscopy and spectroscopy. It would also be useful for applications such as X-ray diffraction studies for structure determination, X-ray interferometry, X-ray fluorescence spectroscopy, X-ray absorption spectroscopy, etc.

The present invention is illustrated by the following examples and figures. It is to be understood that the disclosed methodology is not limited to the exact details briefed here and variations to implement the idea are possible. The methodology described is for the purpose of description and should not be taken as limitation.

### DETAILED DESCRIPTION OF THE ACCOMPANYING FIGURES

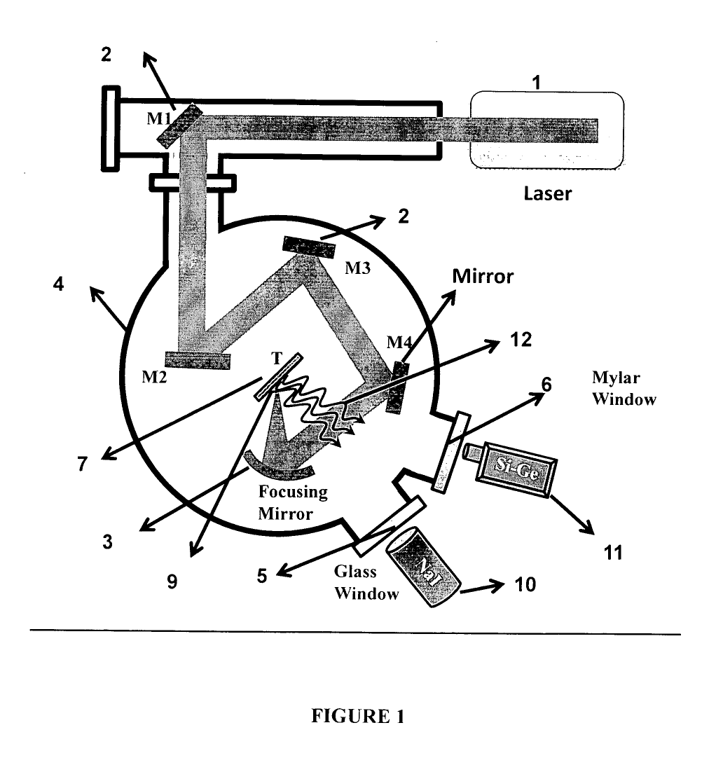

FIG. 1 gives an overview of the apparatus that is used for the laser produced plasma. The method requires an intense laser that produces the plasma. This is shown as element 1 and can be any laser that can deliver intensities larger than 10¹¹ W cm⁻². The laser beam is brought into a vacuum chamber and the associated optical elements used to control the path of the laser beam are shown as element 2 in the figure. This is a system of mirrors and the exact number and arrangement of the mirrors is not unique. It would change depending on the size of the system. The target and some of the optical elements are placed in a vacuum chamber referred to as element 4. The pressure inside the vacuum chamber is about 10⁻³ Torr. Although the exact value of the pressure in the chamber is not critical, it has to be low enough to allow unaffected transit of the incident laser beam so that the entire laser energy is absorbed only on the desired target material. The laser beam is focused with an optical element such as a lens or parabolic/spherical mirror, referred to as element 3 in FIG. 1, on to a target shown as element 7. The laser is absorbed on the target and produces hot-dense plasma. Hot plasma has hot-electrons, high energy ions and high energy photons. The high energy photon emission occurs over a very wide range of energy panning from the Ultraviotlet to hard X-rays. The high energy photons, UV/EUV or X-rays which can be used for further application and this emission is denoted as element 12 in the diagram. The chamber could also have a glass window, element 5, across which X-ray emission can be monitored using 10, a NaI(Ti) detector. The system can be made with a Mylar window, referred to as element 6, across which low energy X-rays from 1.5 keV to 20 keV can be measured by using a detector like 11 the Si(Li) detector.

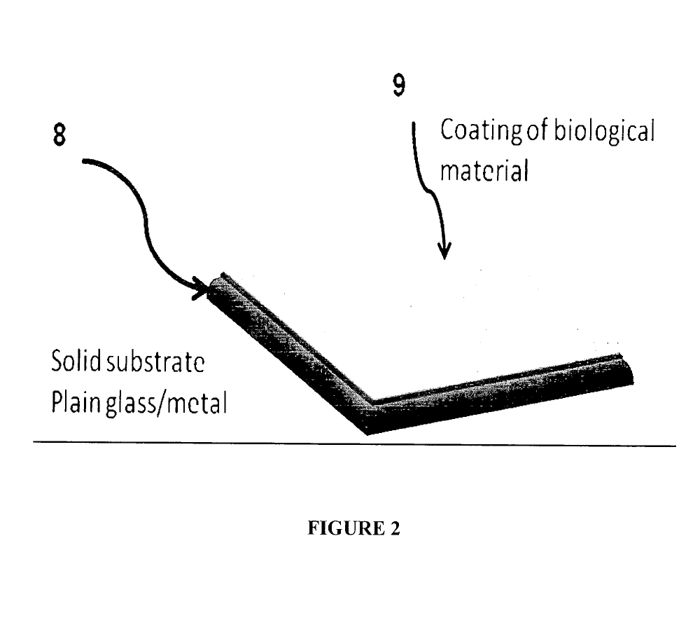

FIG. 2 shows the preferred embodiment of the target arrangement. It contains a solid substrate over which a thin layer of biological cellular material 9 is coated. The element 8 can be a piece of solid metal or glass or a strip of foil or a rolling cartridge as those described in U.S. Pat. No. 5,151,928, on the surface of which a coating 9 is made. Element 9 is biological matter, such as cells from microbial protozoa and plankton origin.

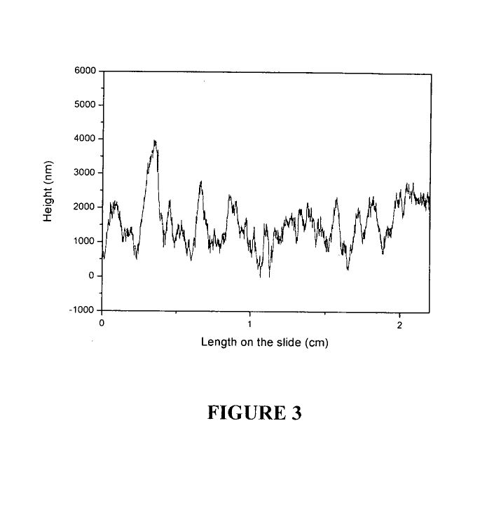

FIG. 3 shows the measurements of the thickness of the bacterial coating and the uniformity obtained by the smearing method described above. The height profile is expected to vary from about 600 nm to 2200 nm for a bacterial monolayer spread on a glass surface. The figure demonstrates that the thickness of the bacterial coating as obtained by our method is within that range.

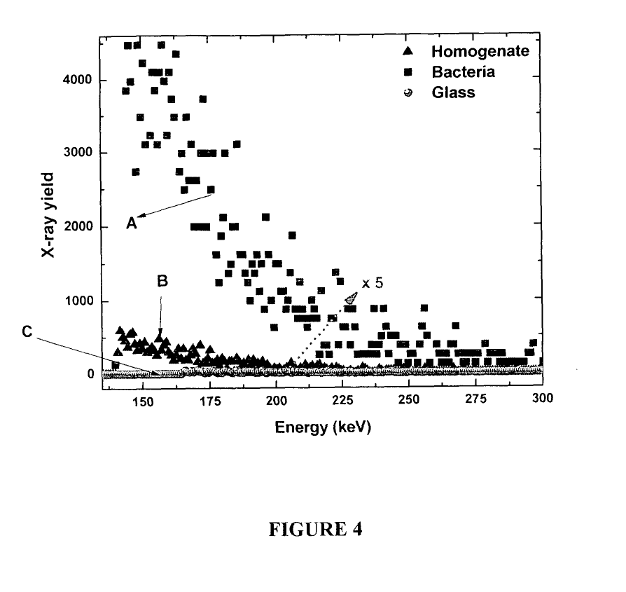

FIG. 4 shows the relative yields of X-rays obtained from different targets viz., glass with bacterial coating, glass without coating and glass with coating of homogenized bacteria. The measurements were limited to the high-energy range to demonstrate the selective advantage of the bacterial coating. It provides data for a wide range of energies. The figure shows the experimental measurements on the bacterial coated targets. It further provides a good estimate of the energy spectrum that would help to determine the plasma temperature. We obtained an X-ray yield that is about 124 times larger in the spectral range 0.01 nm to 0.004 nm with the bacterial coating as compared to the plain solid target. For the same incident laser intensities, the X-ray yield from a liquid droplet target, which is much more difficult to produce inside a vacuum chamber, was only 68 times larger in the 0.01 nm to 0.004 nm spectral range as compared to the plain solid target.

### Example 1

Bacterial suspension in formaldehyde and gluteraldehyde solutions was spread on a solid target and exposed to 250 mJ of 280-300 nm UV to attenuate and fix the cells on to the surface. The target preparation technique used is not unique. A preferred process used was to first paint the target with 1 mg/ml poly-L-lysine solution and then air-dry it for a few minutes. The poly-L-lysine coating creates charged surface on the substrate and thus helps to form uniform coating of the bacterial cells that stick well onto the surface. The cell-suspension, live or fixed, are spread over the charged solid surface and then air dried in a laminar flow hood followed by UV irradiation in a suitable chamber with appropriate dose. Many techniques can be used to spread the bacterial cells and any method, which would produce a uniform layer, would work for the target preparation. The coated target slabs are then left to dry in a desiccator.

### Example 2

The height profiles are shown to provide an idea of the uniformity of the coating on the target plates. Height measurements were done using Ambios Profilometer (Model X1-100). This justifies the practice of averaging the data collected from 10000 different positions on each of the coated target. FIG. 3 shows the height profile of the quoting obtained by the smearing method. Average sizes of E. coli cells are: width 700±88 nm and length 1880±432 nm. So the height profile is expected to vary from about 600 nm to 2200 nm if there is a monolayer of bacterial spread. FIG. 3 show that our spreading method generates coating well within these expectations and at most there are 2-3 cell layers of bacteria at certain points.

### Example 3

Femtosecond pulses were focused in the intensity range of 10¹⁴-10¹⁶ Wcm⁻² on the coated target, which was obtained by the method explained in Example 1, and the X-rays emitted from the laser produced plasmas were measured under identical conditions, both from the solid target with the bacterial coating and without it. This gave the relative yields of the enhancements in the X-ray emissions due to the bacterial coating as compared to the bare surface. FIG. 4 shows the energy resolved X-ray spectrum measured with a NaI (Ti) detector. The X-rays are measured over a few thousand laser shots for both plain glass substrate and the bacterial coated surface. The data indicated in ‘A’ refers to the X-ray emission measurements from the laser irradiation of the bacterial coating. The data indicated in ‘C’ refers to the X-ray emission from plain glass substrate under otherwise identical conditions. The data presented in ‘C’ has been multiplied 5 times. The measured counts are normalized over the number of laser shots for the same solid angle of detection to make the comparison. The count rate as observed by the detector are deliberately kept at less than a count in 10 pulses so that the probability of two X-ray photons reaching the detector within the dead time is negligible and the measured X-ray spectrum can be used to obtain the temperature of the plasma. The X-ray emission yield is more than two orders of magnitude larger, about 124 times as shown in FIG. 4, with the bacterial coating on the target as compared to the bare solid substrate at the same laser intensity. The exact enhancement could vary a few percent depending on the bacterial growth stage, package density of the bacteria over the solid substrate etc. The plasma temperatures caused due to the incident laser field could be easily derived from the X-ray emission spectra by using the Maxwell-Boltzmann statistics. We find that that the temperature of the plasma generated due to bacterial coating on a solid slab target is 2-3 times larger than that observed if there was no bacterial coating.

Since the most important feature is the shape of the cell, which changes the local fields and the coupling of the incident light to the matter in producing this plasma, it is important to test the same. A very similar experiment was set up for comparing the X-ray emission with the homogenized bacteria. The solid substrate was divided into three equal portions: the middle portion was left without any coating (blank); a portion on one side was coated with intact bacterial cell suspension; and a third portion on the other side of the blank strip was coated with bacterial homogenate prepared by sonication with ultra high frequency sound vibrations. The quality of the preparations was verified under transmission electron microscope (TEM; Model Zeiss LIBRA 120 EFTEM), and the thickness and uniformity of the coatings was measured by Ambios Profilometer Model XL-100. Also shown in FIG. 4 is the X-ray emission from the third portion of homogenized bacterial coating under identical conditions of laser irradiation. The data referred as ‘B’ in the figure shows the measured X-rays from the homogenized bacteria. It produced only a few times (up to 10×) larger X-ray yield as compared to the blank solid substrate. FIG. 4 thus clearly shows that the coating of intact bacterial cells is very effective in increasing the yield of X-ray emission by more than two orders of magnitude.

1. A thin film of biological matter disposed on solid substrate adapted to absorb laser pulses to generate hot dense plasma resulting in the emission of radiation

2. The thin film as claimed in claim 1 wherein biological matter comprises cells selected from microbes, protozoa and planktons.

3. The thin film as claimed in any preceding claim wherein biological matter is a 2 to 3 cell layer film.

4. The thin film as claimed in any preceding claim wherein biological matter is either live or fixed.

5. The thin film as claimed in any preceding claim wherein dense plasma formed has a energy range of about 35 to 60 keV.

6. The thin film as claimed in any preceding claim wherein radiation emitted is Ultra Violet, Extreme Ultra violet, x-ray and the hard x-ray.

7. The thin film as claimed in claim 6 wherein radiation emitted is X-rays.

8. The thin film as claimed in any preceding claim wherein the solid substrate is selected from glass, metal, organic material and inorganic material.

9. A target for laser produced plasma system comprising thin film of biological matter disposed on solid substrate.

10. A laser produced plasma system comprising:
a laser producing source,
the target as claimed in claim 8,
a system of optical elements for targeting the laser beam on to the target,
plurality of detectors,
a vacuum chamber containing the target and the said system of optical elements;
wherein the laser produced from the said laser producing source is guided by the optical elements on to the said target, leading to the generation of hot plasma which results in emission of radiation over a wide spectral range with wavelengths down to 0.004 nm.

11. A method of producing X-rays said process comprising targeting laser beams on target comprising biological material disposed on solid substrate, generation of hot plasma and emission of X-rays.

12. A method as claimed in claim 10, which is free from high Z metal debris.
